(19) United States
(12) Patent Application Publication
(10) Pub. No.: US 2008/0070576 A1
(43) Pub. Date: Mar. 20, 2008

(54) Method of handoff in a wireless communication system

(76) Inventors: Susan Wu Sanders, Bridgewater, NJ (US); Carl Francis Weaver, Morris Plains, NJ (US); Qinqing Zhang, Morganville, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/524,174

(22) Filed: Sep. 20, 2006

(51) Int. Cl. H04Q 7/20

(52) U.S. Cl. 455/436

(57) ABSTRACT

A method of handoff utilizing a combined signal quality measurement to trigger or initiate a handoff of a mobile station to a plurality of neighbor base stations, wherein the combined signal quality measurement corresponds to a summation of signal quality measurements associated with the plurality of neighbor base stations. The handoff is triggered when the combined signal quality measurement is greater than a handoff threshold. By using the combined signal quality measurement instead of a signal quality measurement of an individual neighbor base station, handoffs can be triggered earlier along a boundary shared by neighbor cells, thereby reducing interference associated with later triggered handoffs. When triggered, the mobile station is handed off to a plurality of neighbor base stations allowing the mobile station to establish simultaneous communication links with two or more neighbor base station. This increases the chance that at least one of the communication links or the combination thereof is a strong communication link, thereby improving the reliability and success rate of handoffs.

### FIELD OF THE INVENTION

The present invention relates generally to wireless communication systems and, in particular, to handoffs of calls in wireless communication systems.

### BACKGROUND OF THE RELATED ART

A handoff is a technique for keeping a call active in a wireless communication system as a mobile station travels from one cell, i.e., coverage area of a base station, to another cell. During a call, the mobile station communicates with its serving base station over a communication link, i.e., traffic channel, while monitoring pilot signals of neighbor base stations. A handoff will be triggered when the mobile station detects a strong pilot signal, i.e., strength of pilot signal is greater than a threshold value, from at least one of the neighbor base stations. Upon triggering the handoff, the mobile station will attempt to establish a new communication link with the neighbor base station associated with the strong pilot signal and complete the handoff.

The new communication link may be in the same or different frequency band as the original communication link. In the former case, the handoff is referred to as an “intra-frequency handoff.” In the latter case, the handoff is referred to as an “inter-frequency handoff.” In Code Division Multiple Access (CDMA) based wireless communication systems, intra-frequency handoffs are typically soft handoffs and inter-frequency handoffs are typically hard handoffs.

A soft handoff allows the mobile station to have communication links with multiple base station simultaneously. A soft handoff is initiated when the mobile station detects a pilot signal from one of the neighbor base stations with a signal strength greater than a threshold referred to as an “add soft handoff threshold.” The mobile station will establish the new communication link with that neighbor base station while maintaining the original communication link with its serving base station. The original communication link will not be terminated until the pilot signal of the neighbor base station has a signal strength greater than a second threshold referred to as a ‘drop soft handoff threshold.”

By contrast, a hard handoff does not involve the mobile station having communication links with multiple base stations simultaneously. A hard handoff is triggered when the mobile station detects a pilot signal with a signal strength greater than a “hard handoff threshold.” The original communication link with the serving base station will be terminated before the new communication link with the neighbor base station is established.

Setting the hard handoff threshold too high or too low could have an adverse affect on system performance. A hard handoff threshold that is set too low can result in a handoff being triggered when the mobile station is far away from the neighbor base station to which it is being handed off. In such a situation, the new communication link may be weak, which can result in the call being dropped. By contrast, a hard handoff threshold that is set too high can result in a handoff being triggered when the mobile station is far away from the serving base station. In such a situation, prior to the handoff, the mobile station will need to transmit at a high power level to the serving base station in order for the serving base station to receive its transmissions successfully. Such transmissions may result in interference being unnecessarily increased in the neighbor and serving cells before the handoff is completed. It may also result in the handoff never being triggered, for example, because the original communication link is weak or lost before information necessary for initiating and completing the handoff can be signaled to and from the serving base station.

To further complicate matters, there is no single hard handoff threshold which is appropriate or ideal, i.e., not too high or too low, for all paths a mobile station may travel while traversing from one cell to another. This point can be illustrated using FIG. 1, which depicts a wireless communication system 100 comprising base stations 110, 120 and 130 and mobile stations 140 and 150. Base stations 110, 120 and 130 serve, i.e., provide telecommunication services to, mobile stations within their associated cells 115, 125 and 135, respectively. With respect to mobile stations 140 and 150, base station 110 would be the serving base station and base stations 120 and 130 would be neighbor base stations. Mobile station 140 is traveling along path 145 towards the center of cell 125, and mobile station 150 is traveling along path 155 towards a boundary shared by neighbor cells 125 and 135.

In the illustrative example of FIG. 1, suppose the hard handoff threshold is set appropriately for mobile station 140 traveling along path 145, or any mobile station traveling along a path spanning approximately from the center of one cell to the center of another cell. The pilot signal strength of neighbor base station 120 at mobile station 140 will be greater than the hard handoff threshold, i.e., hard handoff is triggered, when mobile station 140 is a distance x from serving base station 110, wherein x is some value greater than zero.

By contrast, mobile station 150 is not traveling along a path spanning approximately from the center of one cell to the center of another cell. Mobile station 150 is traveling a path between the center of serving cell 115 (i.e., base station 110) and a boundary shared by cells 125 and 135. The pilot signal strength of neighbor base stations 120 and/or 130 does not become greater than the hard handoff threshold until mobile station 150 is a distance y from serving base station 110, where y>x. Thus, mobile station 150 will be farther away from serving base station 110 when the hard handoff is triggered relative to mobile station 140. The farther away mobile station 150 is from serving base station 110, the higher its transmit power. Such higher transmit power can unnecessarily increase interference within cells 115, 125 and 135, in turn, adversely affects system performance. Thus, an appropriate or ideal hard handoff threshold for mobile station 140 traveling along path 145 may not be appropriate or ideal for mobile station 150 traveling along path 155.

Lowering the hard handoff threshold would reduce the interference caused by mobile station 150 in cells 115, 125 and 135. However, the lower hard handoff threshold may cause hard handoffs to be triggered early, which may result in a weak new communication link. Accordingly, there exists a need for a reliable method of inter-frequency handoff that does not cause unnecessary interference in nearby cells.

### SUMMARY OF THE INVENTION

An embodiment of the present invention is a method of handoff utilizing a combined signal quality measurement to trigger or initiate a handoff of a mobile station to a plurality of neighbor base stations, wherein the combined signal quality measurement corresponds to a summation or other combination of signal quality measurements associated with the plurality of neighbor base stations. The handoff is triggered when the combined signal quality measurement is greater than a handoff threshold. By using the combined signal quality measurement instead of a signal quality measurement of an individual neighbor base station, handoffs can be triggered earlier along a boundary shared by neighbor cells, thereby reducing interference associated with later triggered handoffs. When triggered, the mobile station is handed off to a plurality of neighbor base stations allowing the mobile station to establish simultaneous communication links with two or more neighbor base station. This increases the chance that at least one of the communication links or the combination thereof is a strong communication link, thereby improving the reliability and success rate of handoffs.

### BRIEF DESCRIPTION OF THE DRAWINGS

The features, aspects, and advantages of the present invention will become better understood with regard to the following description, appended claims, and accompanying drawings where:

FIG. 1 depicts a wireless communication system used in accordance with the prior art;

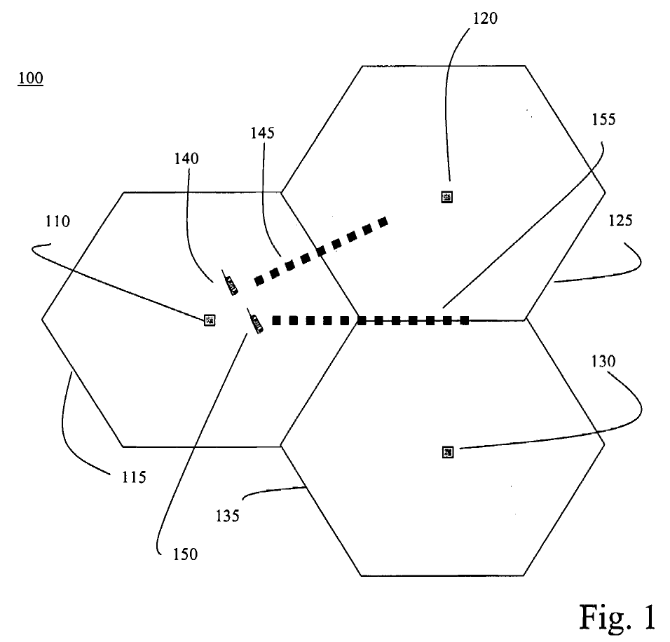

FIG. 2 depicts a wireless communication system used in accordance with one embodiment of the present invention;

FIG. 3 depicts a flowchart illustrating a method of handoff of a Voice over Internet Protocol (VoIP) call in accordance one embodiment of the present invention;

FIG. 4 depicts a flowchart illustrating a method of determining whether to initiate an inter-frequency handoff in accordance with one embodiment of the present invention; and

FIG. 5 depicts a flowchart illustrating a method of determining whether to initiate an inter-frequency handoff in accordance with another embodiment of the present invention.

### DETAILED DESCRIPTION

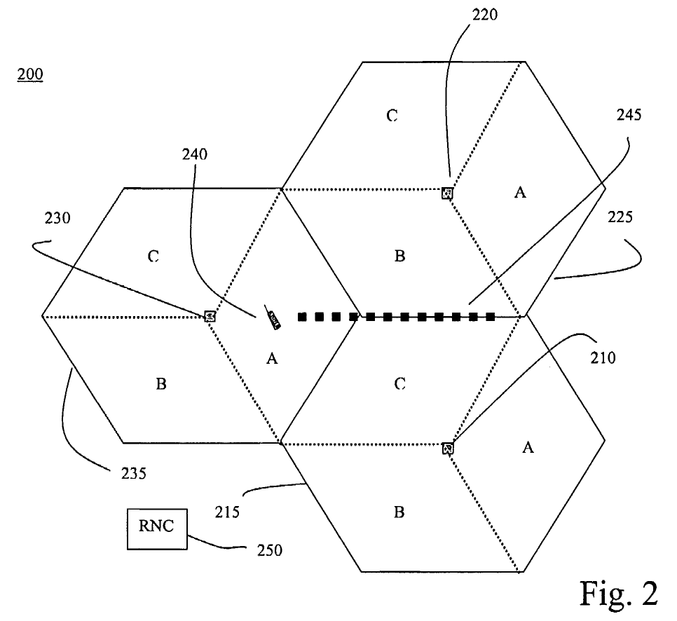

For purposes of discussion, the present invention will be described herein with respect to FIG. 2, which depicts a wireless communication system 200. Wireless communication system 200 incorporates the well-known Code Division Multiple Access 2000 (CDMA2000) radio interface standard. This should not be construed to limit the present invention to only CDMA2000 based wireless communication systems.

Wireless communication system 200 comprises base stations 210, 220 and 230, mobile station 240 and radio network controller (RNC) 250. Base stations 210, 220 and 230 provide telecommunication services to mobile stations within their geographical coverage areas or cells 215, 225 and 235, wherein each cell 215, 225 and 235 includes a plurality of co-located cells. Each cell 215, 225 and 235 (or co-located cells) can be divided into a plurality of sectors A, B and C.

Telecommunication services are provided to mobile stations within each of the plurality of co-located cells using a radio interface and a frequency band. In one embodiment, each cell 215, 225 and 235 comprises of a plurality of co-located cells which use different radio interfaces, thus, each cell 215, 225 and 235 is associated with a set of radio interfaces. Specifically, in this embodiment, cells 215 and 225 each comprises a co-located cell which uses the well-known CDMA2000 1x radio interface (also referred to herein as a “3G1x cell”) and a co-located cell which uses the well-known CDMA2000 EV-DO Rev 0 radio interface (also referred to herein as a “DO Rev 0 cell”), and cell 235 comprises a 3G1x cell and a co-located cell which uses the well-known CDMA2000 EV-DO Rev A radio interface (also referred to herein as a “DO Rev A cell”). Circuit calls are supported by 3G1x cells, wherein Voice over Internet Protocol (VoIP) calls are supported by DO Rev A cells. DO Rev 0 cells do not support VoIP calls nor circuit calls.

In 3G1x cells, telecommunication services are provided over a first frequency band, referred to herein as a “3G1x band.” In DO Rev 0 and DO Rev A cells, telecommunication services are provided over a second frequency band, referred to herein as a “DO band.” A set of communication channels are used for communication over each of the frequency bands. Each set of communications channels include a pilot channel, a control channel and a plurality of traffic channels.

When a mobile station travels across the coverage area of wireless communication system 200, the call is handed off from one cell to another in order to keep the call active. The present invention is a method of handoff which utilizes a combined signal quality measurements from a plurality of cells to trigger the handoff. The present invention will be described herein with respect to an illustrative embodiment involving an inter-frequency handoff in which a VoIP call is converted to a circuit call. This should not be construed to limit the present invention in any manner.

In the illustrative embodiment, mobile station 240 is in a VoIP call and traveling along path 245 in cell 235, which as a 3G1x/DO Rev A cell. Base station 230 is its serving base station, and base stations 210 and 220 are its neighbor base stations. As mobile station 240 approaches cells 215 and 225, the VoIP call will be handed off to neighbor base stations 210 and 220 and converted to a circuit call because cells 215 and 225 are 3G1x/DO Rev 0 cells, which do not support VoIP calls. VoIP calls are carried over the DO band, whereas circuit calls are carried over the 3G1x band, thus the handoff will be an inter-frequency handoff.

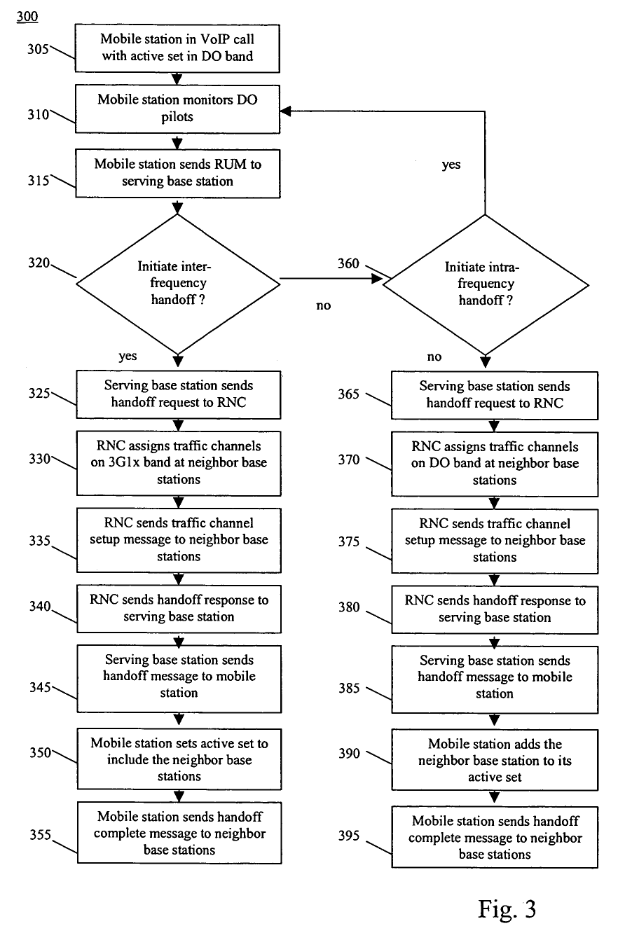

FIG. 3 depicts a flowchart 300 illustrating a method of handoff of a VoIP call in accordance with the illustrative embodiment. In step 305, mobile station 240 is in a VoIP call with base stations in its active set, wherein the active set includes a serving base station and zero or more secondary base stations. In step 310, mobile station 240 measures the signal strengths of pilot signals, i.e., signals transmitted over the pilot channels, transmitted by base stations 210, 220 and 230 over the DO band. Such pilot signals are also referred to herein as “DO pilots.” Each base station transmits a same DO pilot using a different offset such that mobile stations can identify the source of the DO pilot. Similarly, each base station transmits a same 3G1x pilot, i.e., pilot signal transmitted over the 3G1x band, using a different offset such that mobile stations can identify the source of the 3G1x pilot.

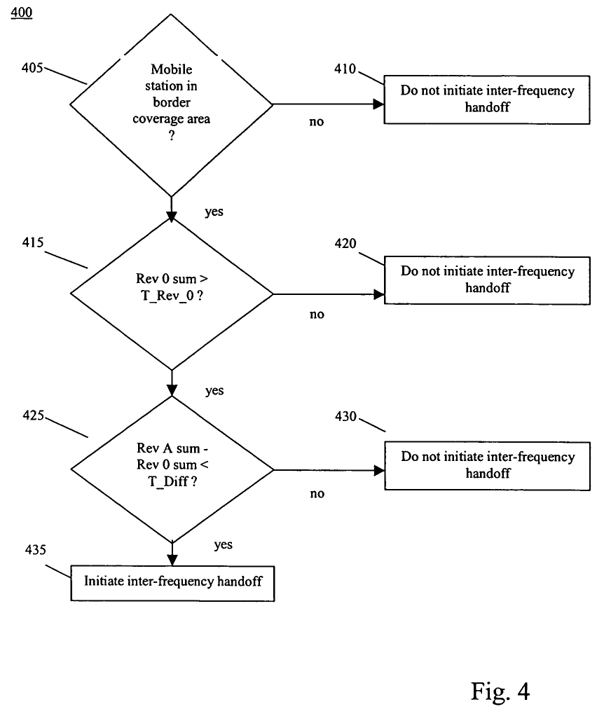

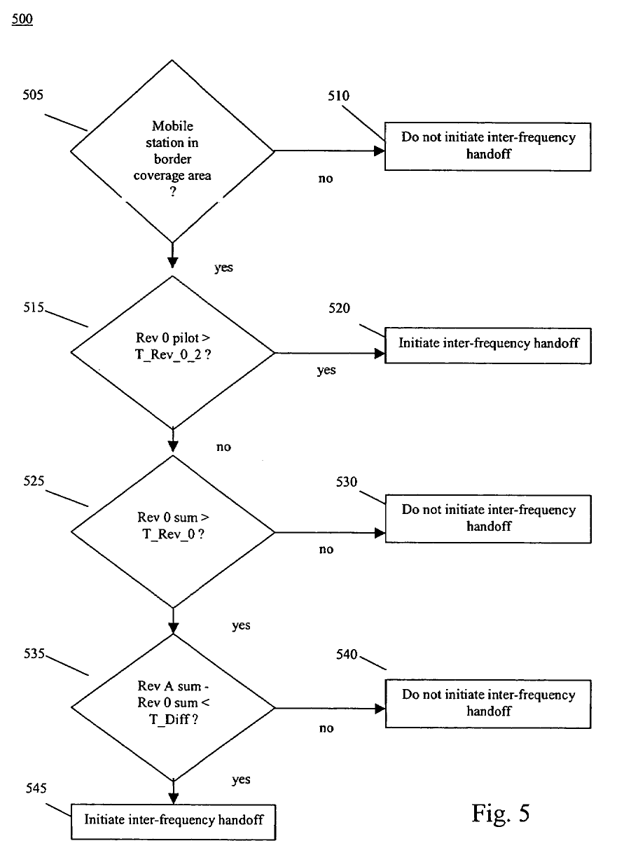

In step 315, mobile station 240 transmits to serving base station 230 a measurement message indicating the signal strength measurements and offsets of the DO pilots, such as a Route Update Message (RUM). In step 320, serving base station 230 determines whether to initiate an inter-frequency handoff to one or more neighboring 3G1x sectors (or cells) based on the RUM. Such a handoff is also referred to herein as a “DO-3G1x handoff.” The manner of determining whether to initiate an inter-frequency handoff will now be described herein with reference to two embodiments illustrated in FIGS. 4 and 5.

FIG. 4 depicts a flowchart 400 illustrating a method of determining whether to initiate a DO-3G1x or inter-frequency handoff in accordance with one embodiment of the present invention. In step 405, base station 230 determines whether mobile station 240 is in a border coverage area. A border coverage area could be a cell or sector associated with a set of radio interfaces that is at least partially adjacent to another cell or sector associated with a different set of radio interfaces. In one embodiment, a border coverage area can be a DO Rev 0 sector or cell which is adjacent to a DO Rev A sector or cell, or a DO Rev A sector or cell which is adjacent to a DO Rev 0 sector or cell. For example, both sector C of cell 215 and sector B of cell 225 are border coverage areas with respect to sector A of cell 235. A translation parameter may be maintained by each base station 210, 220 and 230 for indicating whether the associated cell or sector is a border coverage area. The translation parameter may be, for example, a bit or flag. If the bit is set to 1, it may indicate that the associated cell or sector is a border coverage area. If the bit is set to 0, it may indicate that the associated cell or sector is not a border coverage area.

If mobile station 240 is not in a border coverage area, then flowchart 400 determines in step 410 not to initiate the inter-frequency handoff. Otherwise, flowchart 400 continues to step 415 where base station 230 combines the DO pilot signal strength measurements to determine whether to trigger or initiate the DO-3G1x handoff. Specifically, base station 230 determines whether a sum (or other combination) of the DO pilot signal strength measurements associated with two or more DO Rev 0 sectors (or cells), hereinafter referred to as “Rev 0 sum,” is greater than a first Rev 0 handoff threshold “T_Rev_{—}0,” i.e., Rev 0 sum>T_Rev_{—}0. In one embodiment, the Rev 0 sum can correspond to a summation of DO Rev 0 pilot signal strength measurements associated with a pair of adjacent DO Rev 0 sectors (or cells) which, for example, may include sectors of the serving base station and a neighbor base station. In another embodiment, the Rev 0 sum can correspond to a summation of DO Rev 0 pilot signal strength measurements associated with any number of DO Rev 0 sectors (or cells) indicated in, for example, the Route Update Message (RUM). Note that a combined DO pilot signal strength measurement is used to trigger the DO-3G1x handoff instead of individual DO pilot signal strength measurements. Such combination allows the DO-3G1x handoff to be triggered earlier when, for example, the mobile station is traveling along a boundary shared by neighbor cells, thereby reducing interference the mobile station would have caused if individual DO pilot signal strength measurements were used to trigger the DO-3G1x handoff.

In one embodiment, a list of neighbor base stations, i.e., neighbor list, may be used to identify which DO pilot signal strength measurement are associated with DO Rev 0 sectors (or cells) and DO Rev A sectors (or cells). The neighbor list can indicate whether a base station or its associated sector (or cell) utilizes a 3G1x, DO Rev 0 and/or DO Rev A radio interface. The neighbor list may be maintained by each base station 210, 220 and 230, or by some other entity, such as RNC 250.

If, in step 415, it is determined that the Rev 0 sum is not greater than the first Rev 0 handoff threshold T_Rev_{—}0, then base station 230 does not initiate the inter-frequency handoff in step 420. If it is determined that the Rev 0 sum is greater than the first Rev 0 handoff threshold T_Rev_{—}0, then base station 230 determines in step 425 whether a sum (or other combination) of the DO pilot signal strength measurements for the DO Rev A sectors (or cells), hereinafter referred to as “Rev A sum,” minus the Rev 0 sum is less than a differential handoff threshold “T_Diff,” i.e., Rev A sum−Rev 0 sum<T_Diff. In one embodiment, the Rev A sum can correspond to a summation of DO Rev A pilot signal strength measurements for base stations in the active set. In another embodiment, the Rev A sum can correspond to a summation of DO Rev A pilot signal strength measurement for only the serving base station or DO Rev A pilot signal strength measurements for any number of base stations indicated in the RUM.

If the difference between Rev A sum and Rev 0 sum is not less than the differential handoff threshold T_Diff, then base station 230 determines not to initiate the inter-frequency handoff in step 430. Otherwise, base station 230 determines to initiate the inter-frequency handoff in step 435 to the base stations associated with the pilots combined in the Rev 0 sum.

Note that, in step 415, the present invention is checking to make sure that the difference between the Rev A sum and the Rev 0 sum is not less than the differential handoff threshold T_Diff. This check provides assurances against triggering the handoff too early, especially when the DO band signal quality between mobile station 240 and the base stations in its active set, i.e., DO Rev A base stations, is stronger than the DO band signal quality between mobile station 240 and the neighbor DO Rev 0 base stations.

FIG. 5 depicts a flowchart 500 illustrating a method of determining whether to initiate a DO-3G1x or inter-frequency handoff in accordance with another embodiment of the present invention. In step 505, base station 230 determines whether mobile station 240 is in a border coverage area using, for example, the translation parameter. If mobile station 240 is not in a border coverage area, then flowchart 500 determines not to initiate the inter-frequency handoff in step 510.

Otherwise, in step 515, base station determines whether at least one DO pilot signal strength measurement associated with a DO Rev 0 sector (or cell) of a neighbor base station, hereinafter referred to as “Rev 0 pilot,” is greater than a second Rev 0 handoff threshold “T_Rev_{—}0_{—}2,” i.e., Rev 0 pilot>T_Rev_{—}0_{—}2. If a DO pilot signal strength measurement from at least one neighbor base station is greater than the second Rev 0 handoff threshold T_Rev_{—}0_{—}2, then the serving base station determines in step 520 to initiate the inter-frequency handoff to the neighbor base station associated with that DO pilot signal strength measurement.

Otherwise, flowchart 500 continues to step 525 where base station 230 determines whether the Rev 0 sum, e.g., summation of DO pilot signal strength measurements of two or more DO Rev 0 sectors or cells, is greater than the first Rev 0 handoff threshold T_Rev_{—}0, i.e., Rev 0 sum>T_Rev_{—}0. In one embodiment, the first Rev 0 handoff threshold T_Rev_{—}0 is set greater than the second Rev 0 handoff threshold T_Rev_{—}0_{—}2.

If it is determined that the Rev 0 sum is not greater than the Rev 0 handoff threshold T_Rev_{—}0, then base station 230 does not initiate the inter-frequency handoff in step 530. Otherwise, base station 230 determines in step 535 whether the Rev A sum minus the Rev 0 sum is less than the differential handoff threshold T_Diff, i.e., Rev A sum−Rev 0 sum<T_Diff.

If the difference between Rev A sum and Rev 0 sum is not less than the differential handoff threshold T_Diff, then base station 230 determines not initiate the inter-frequency handoff in step 540. Otherwise, base station 230 determines to initiate the handoff in step 545 to the base stations associated with the pilots used in the Rev 0 sum.

Note that, in an alternate embodiment, if it is determined in steps 415 or 525 that the Rev 0 sum is greater than the first handoff threshold T_Rev_{—}0, then the inter-frequency handoff may be initiated without continuing to steps 425 or 535, respectively. In yet another alternate embodiment, steps 415 and 525 may be bypassed or eliminated and inter-frequency handoff may be initiated based solely on steps 425 and 535.

Returning to FIG. 3, if it is determined in step 320 that an inter-frequency (or DO-3G1x) handoff is to be initiated, flowchart 300 continues to step 325 where base station 230 sends a handoff request to RNC 250 indicating the base stations to which the VoIP call is to be transferred or handed off. In step 330, RNC 250 will attempt to allocate resources for setting up traffic channels, i.e., assigns traffic channels, on the 3G1x band at the base stations indicated in the handoff request. Note that resources may not be allocated to all base stations indicated in the handoff request due to resource availability. In step 335, RNC 250 transmits a traffic channel setup message to the base stations at which the resources have been allocated. The traffic channel setup message indicates the resources being allocated to mobile station 240 at the relevant base stations.

In step 340, RNC 250 sends a handoff response to serving base station 230 indicating the assigned traffic channels and associated base stations. In step 345, serving base station 230 transmits a handoff message to mobile station 240 indicating the assigned traffic channels and associated base stations. Upon receiving the handoff message, in step 350, mobile station 240 sets its active set to include the base stations indicated in the handoff message.

In step 355, mobile station 240 sends a handoff complete message to the base stations in order to establish communication links with the base stations using the assigned traffic channels. The VoIP call is dropped and a circuit call is established in the 3G1x band.

Note that the call is handed off to a plurality of base stations allowing the mobile station to establish simultaneous communication links with two or more base stations. This will increase the chance that at least one of the communication links or the combination thereof is a strong communication link, thereby improving the reliability and success rate of the handoff. In one embodiment, the plurality of base stations to which the call is handed off may or may not include the serving base station.

If it is determined in step 320 that an inter-frequency (or DO-3G1x) handoff is not to be initiated, then flowchart 300 continues to step 360 where base station 230 determines whether to initiate an intra-frequency handoff to one or more neighbor DO Rev A sectors (or cells), i.e., DO-DO handoff. Specifically, base station 230 determines whether any DO Rev A sectors (or cells) are associated with a DO pilot signal strength measurement greater than a Rev A handoff threshold “T_Rev_A.” In one embodiment, the Rev A handoff threshold T_Rev_A is less than the first Rev 0 handoff threshold T_Rev 0.

If no DO pilot signal strength measurement associated with a DO Rev A sector (or cell) is greater than T_Rev_A, flowchart 300 returns to step 310. Otherwise, flowchart 300 continues to step 365 where base station 230 sends a handoff request to RNC 250 indicating the DO Rev A sectors (or cells) to which the VoIP call is to be transferred or handed off. In step 370, RNC 250 will attempt to allocate resources for setting up traffic channels on the DO band at the base stations indicated in the handoff request. In step 375, RNC 250 transmits a traffic channel setup message to the base stations at which the resources have been allocated. The traffic channels setup message indicates the resources allocated to mobile station 240 at the relevant base stations.

In step 380, RNC 250 sends a handoff response to serving base station 230 indicating the assigned traffic channels and associated base stations. In step 385, serving base station 230 transmits a handoff message to mobile station 240 indicating the assigned traffic channels and associated base stations. Upon receiving the handoff message, in step 390, mobile station 240 adds the neighbor base station associated with the assigned traffic channels to its active set. In step 395, mobile station 240 sends a handoff complete message to the base stations in order to establish communication links with the base stations using the assigned traffic channels and complete the handoff.

The present invention have been described herein with reference to certain embodiments. This should not be construed to limit the present invention to these embodiments. Other embodiments are possible. For example, flowcharts 400 and 500 used for determining whether to initiate an inter-frequency handoff may also be used for determining whether to initiate intra-frequency handoff. Another example may involve handing off the call from a serving base station in one wireless communication system to neighbor base stations in another wireless communication system. Therefore, the spirit and scope of the present invention should not be limited to the description of the embodiments contained herein

1. A method of handoff in a wireless communication system during system access comprising the step of:
initiating a handoff of a mobile station in a call with a serving base station to a plurality of neighbor base stations based on a first combined measurement corresponding to a combination of signal quality measurements associated with the plurality of neighbor base stations.

2. The method of claim 1, wherein the handoff is an inter-frequency handoff from a first frequency band to a second frequency band, and the first combined measurement corresponds to a summation of signal quality measurements associated with the plurality of neighbor base stations in the first frequency band.

3. The method of claim 1, wherein the handoff is initiated if the first combined measurement is greater than a handoff threshold.

4. The method of claim 1, wherein the handoff is initiated if the first combined measurement is greater than a handoff threshold and if a difference between a second combined measurement minus the first combined measurement is less than a differential threshold, the second combined measurement corresponding to a combination of signal quality measurements associated with one or more base stations in an active set.

5. The method of claim 3, wherein the handoff is initiated if a difference between a second combined measurement minus the first combined measurement is less than a differential threshold, the second combined measurement corresponding to a combination of signal quality measurements associated with one or more base stations in an active set.

6. The method of claim 1, wherein the plurality of neighbor base stations comprises two adjacent neighbor base stations.

7. The method of claim 1, wherein the mobile station is in a Voice over Internet Protocol (VoIP) call with the serving base station and the VoIP call is converted to a circuit call with the plurality of neighbor base stations upon completion of the handoff.

8. A method of handoff in a wireless communication system during system access comprising the steps of:
determining whether to initiate a handoff to an individual neighbor base station based on a signal quality measurement associated with the individual neighbor base station; and
determining whether to initiate a handoff to a plurality of neighbor base stations based on a first combined measurement corresponding to a combination of signal quality measurements associated with the plurality of neighbor base stations if it was determined not to initiate the handoff to an individual neighbor base station.

9. The method of claim 8, wherein the handoff is initiated to the individual neighbor base station if the signal quality measurement associated with the individual neighbor base station is greater than a handoff threshold.

10. The method of claim 8, wherein the handoff is initiated to the plurality of neighbor base stations if the first combined measurement is greater than a handoff threshold.

11. The method of claim 8, wherein the handoff is initiated to the plurality of neighbor base stations if the first combined measurement is greater than a handoff threshold, and if a difference between a second combined measurement minus the first combined measurement is less than a differential threshold, the second combined measurement corresponding to a combination of signal quality measurements associated with one or more base stations in an active set.

12. The method of claim 8, wherein the handoff is initiated to the plurality of neighbor base stations if a difference between a second combined measurement minus the first combined measurement is less than a differential threshold, the second combined measurement corresponding to a combination of signal quality measurements associated with one or more base stations in an active set.

13. The method of claim 8, wherein the handoff is an inter-frequency handoff from a first frequency band to a second frequency band, and the signal quality measurement associated with the individual neighbor base station and the first combined measurement corresponds to signal quality measurements in the first frequency band.

14. The method of claim 8, wherein a mobile station in a Voice over Internet Protocol (VoIP) call with a serving base station and the VoIP call is converted to a circuit call with the individual neighbor base station or the plurality of neighbor base stations upon completion of the handoff.

15. A method of handoff in a wireless communication system comprising the steps of:
transmitting a measurement message indicating measurements of signal quality in a first frequency band associated with a plurality of neighbor base stations; and
receiving a handoff message indicating assigned communication channels in a second frequency band associated with the plurality of neighbor base stations.

16. The method of claim 15 comprising the additional step of:
establishing communication links with the plurality of neighbor base stations using the assigned communication channels.

17. The method of claim 15, wherein the measurement message is transmitted by a mobile station in a Voice over Internet Protocol (VoIP) call

18. The method of claim 17, wherein the VoIP call is converted to a circuit call upon completion of a handoff to the plurality of neighbor base stations.
